(19) United States
(12) Patent Application Publication
(10) Pub. No.: US 2010/0223660 A1
(43) Pub. Date: Sep. 2, 2010

(54) PROVIDING MULTIMEDIA CONTENT WITH TIME LIMIT RESTRICTIONS

(75) Inventors: Charles Varnon Scott, Austin, TX (US); Ankur Mukerji, Auburn, CA (US); Scott Anthony White, Austin, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/395,418

(22) Filed: Feb. 27, 2009

(51) Int. Cl. H04L 9/32

(52) U.S. Cl. 726/4

(57) ABSTRACT

Users are provided limited access to multimedia programs. An administrator may require users to log in to begin a multimedia distribution session (e.g., a television program viewing session). The administrator may designate that certain users may access multimedia content only for an allotted amount of time during an approved viewing period. The administrator may also designate that a maximum amount of rollover time is carried to a future tracking period if an allotted amount of viewing time is not fully used for any tracking period.

### BACKGROUND

1. Field of the Disclosure

The present disclosure generally relates to multimedia content distribution networks and more particularly to providing multimedia content with certain restrictions.

2. Description of the Related Art

Multimedia content may be received over a multimedia content distribution network (MCDN). In traditional systems, a parent or administrator has limited resources for controlling access to multimedia content.

### BRIEF DESCRIPTION OF THE DRAWINGS

FIG. 1 illustrates a representative Internet protocol television (IPTV) architecture for providing multimedia content and, in accordance with disclosed embodiments, controlling access to multimedia content;

FIG. 2 is a block diagram of selected elements of a multimedia processing resource which may be used in accordance with disclosed embodiments to provide limited access to multimedia content;

FIG. 3 illustrates selected operations in a method for providing limited access to multimedia content; and

FIG. 4 illustrates selected operations in a method for providing limited access to multimedia content.

### DESCRIPTION OF EXEMPLARY EMBODIMENTS

Multimedia content (e.g., a television program) is provided to users by service providers that provide access to the content over the Internet or other networks. Portions of the multimedia content may be unsuitable for some users, and local administrators (e.g., parents) may wish to control access to the content. In some cases, an administrator may wish to limit the amount of multimedia content received by some or all local users. In such cases, parental or administrator controls may be implemented to provide limited access to available multimedia content.

Accordingly, some disclosed systems provide administrator controlled access to multimedia content for a limited time during a defined viewing period. For example, an administrator may limit a user to accessing multimedia content for two hours per day. Such restrictions may be imposed by the administrator through management of permission settings associated with user accounts. Users may be required initially to provide log in credentials to access multimedia content. An administrator may set permission settings for users that only allow an allotted amount of time (e.g., three hours) for viewing multimedia content. Once the allotted time has expired, a user may be automatically logged out and may be unable to log in again until the following viewing period. For example, a user may be automatically logged out after viewing multimedia content for an allotted time of three hours and may be restricted from logging in again until the following day. Some disclosed systems provide rollover time to users if the users do not use all of the allotted time for a viewing period.

In an exemplary embodiment, an administrator establishes access levels for users. The administrator may designate identical or different permission settings for each member of an access level. For example, access levels may be defined as “restricted” and “unrestricted” or “child” and “adult.” For a member of an unrestricted access level, there may be no restrictions as to the time of day or amount of content that is received. In contrast, for members of a restricted access level, an administrator may designate a maximum number of minutes (i.e., an allotted time) that may be used for accessing multimedia content per day, per week, per month, or per other viewing (i.e., per tracking period).

In some embodiments, any unused minutes for a viewing period may be rolled over to the next viewing period. An administrator may restrict the number of minutes that are rolled over to a subsequent viewing period. For example, an administrator may establish that only 20 unused minutes may roll over to a future viewing period. Alternatively, an administrator may establish permission settings for a user that allow rolling over a certain percentage (e.g., 20%) of the allotted time that remains unused at the end of a viewing period.

In some embodiments, an administrator may include permission settings that define which hours of a day each access level is permitted to access multimedia content. For example, the access level “child” may be prevented from accessing multimedia content between the hours of 9 PM and 7 AM. In some embodiments, an administrator may provide different settings for weekdays, holidays, and weekends. Accordingly, a user that belongs to a restricted access level (e.g., a child) may exercise discretion over the multimedia content that the user accesses, but access to the multimedia content is controlled by the time allotted by an administrator and by the windows of time that are available for using the allotted time.

Some embodiments restrict a user from accessing a multimedia program for more than a predetermined number of views (e.g., a single view). Also, the user may be restricted to using the predetermined number of views within a predetermined amount of time. For example, an administrator may designate that a user may access a multimedia program for a single view, and the user may take three hours for the single view. If the multimedia program has a duration of two hours, the user may take up to an hour break while accessing the multimedia program.

In addition to these restrictions, the predetermined number of views may be limited to a defined period (e.g., a week). So in the above example, an administrator may designate that a user has access to a multimedia program for a single view and the user may take up to three hours over the next week to view the multimedia program. This permits an administrator to control the number of times a user accesses a multimedia program and the period during which the multimedia program may be accessed.

To implement the features and restrictions disclosed herein, parental control settings may be added to a localized system (i.e., local to viewing or accessing) that provides multimedia content. For example, a multimedia processing resource (MPR) such as a set-top box (STB) may be enabled with such parental control settings that are integrated within electronic programming guide (EPG) functionality. Users may be required initially, at the beginning of a viewing session, to provide log in credentials. From an enhanced EPG, an administrator (e.g., a parent) may choose a multimedia program (e.g., television show) and select the action “single view” for a particular user or class of user (e.g., a restricted access level). In accordance with some embodiments, the administrator may be required to confirm that the administrator wants viewing of the chosen multimedia program restricted to a single view. The administrator also may be prompted to verify the identity of users that are assigned the “single view” restriction. In addition, the administrator may be prompted to provide the amount of time the user has to complete viewing of the multimedia program. For example, the administrator may restrict a user to a single view of a multimedia program and may designate that the user must complete viewing of the multimedia program within three hours of initially accessing the multimedia program. If the end of the multimedia program is detected or the allotted time is exceeded, the user may be prevented from further accessing the multimedia program. In some embodiments, the user may be prompted to enter an administrator access code for any additional access to the multimedia program.

Accordingly, in one aspect a disclosed service provides limited access to multimedia content. The service includes associating an access level with a user. The access level may be a restricted access level or an unrestricted access level, as examples. If the access level is a restricted access level, the service includes tracking an accumulated time for providing the multimedia content to the user for a tracking period (i.e., a viewing.). Access is limited to further multimedia content by the user if the accumulated time meets or exceeds an allotted time. In some embodiments, the allotted time includes rollover time from a previous tracking period. The included rollover time may be limited by an administrator to a maximum amount per period. The disclosed service may include prompting the administrator to provide input defining the allotted time, the tracking period, and the access level for one or more users.

In another aspect, a disclosed process includes controlling access to a multimedia program. The process includes receiving input from a user, determining user permission settings associated with the user, and determining from the user permission settings whether the user is permitted access to the multimedia program. User permission settings define a presentation period and a time remaining from the allotted time for the presentation period.

In still another aspect, a disclosed computer program includes instructions for receiving administrator input that defines a tracking period for tracking receipt of multimedia content by a user, an allotment of time for receipt of multimedia content by the user, and a viewing period for allowing receipt of the multimedia content by the user.

In another aspect, a disclosed process includes providing controlled access to a multimedia program. The process includes accepting an identifier of the multimedia program and a restriction request from an administrator. The restriction request defines a limited period for accessing the multimedia program by a user. The process further includes associating an access code with a user account and requiring a user to input the access code to view to the multimedia program. The user is provided with a selectable indication of the multimedia program and the user is provided access to the multimedia program for the limited period in response to the user selecting the indication. The process may include initiating a warning sequence if an accumulated access time for the multimedia program is within a predetermined amount of the allotment of time. In some embodiments, an administrator or parent may limit the number of accesses used in viewing the multimedia program. In addition, an end to the multimedia program may be detected and further access to the multimedia program may be denied once the end of the multimedia program is reached. Disclosed processes may permit further access to the multimedia program in response to receiving administrator credentials (e.g., an administrator access code or password).

In another aspect, a disclosed service controls access to the multimedia program and includes receiving administrator input to set an access code for accessing the multimedia program by a user. Responsive to user input to access the multimedia program, eligibility of the user to access the multimedia program is determined by whether the user has provided a valid access code and whether the user has previously accessed the multimedia program. The multimedia program is provided in response to determining that the user is eligible. In some embodiments, administrator input sets a period (e.g., a day) for permissible accessing of the multimedia program by the user. The user may be denied access to the multimedia program if it is determined that the user has previously accessed the multimedia program, if the allotted time has expired, or if the period has expired. If the user is determined to be ineligible for receiving the multimedia program, the service may include requesting an administrator access code responsive to receiving a request to access the multimedia program.

In still another embodiment, a disclosed computer program product includes instructions for accepting from an administrator an identifier of a multimedia program and accepting from the administrator a restriction request to allow limited access to a multimedia program by a user. An access code may be associated with a user account for the user and instructions may require the user to enter the access code for access to the multimedia program. In response to the user selecting an indication of the multimedia program, access to the multimedia program is provided for not more than an allotment of time.

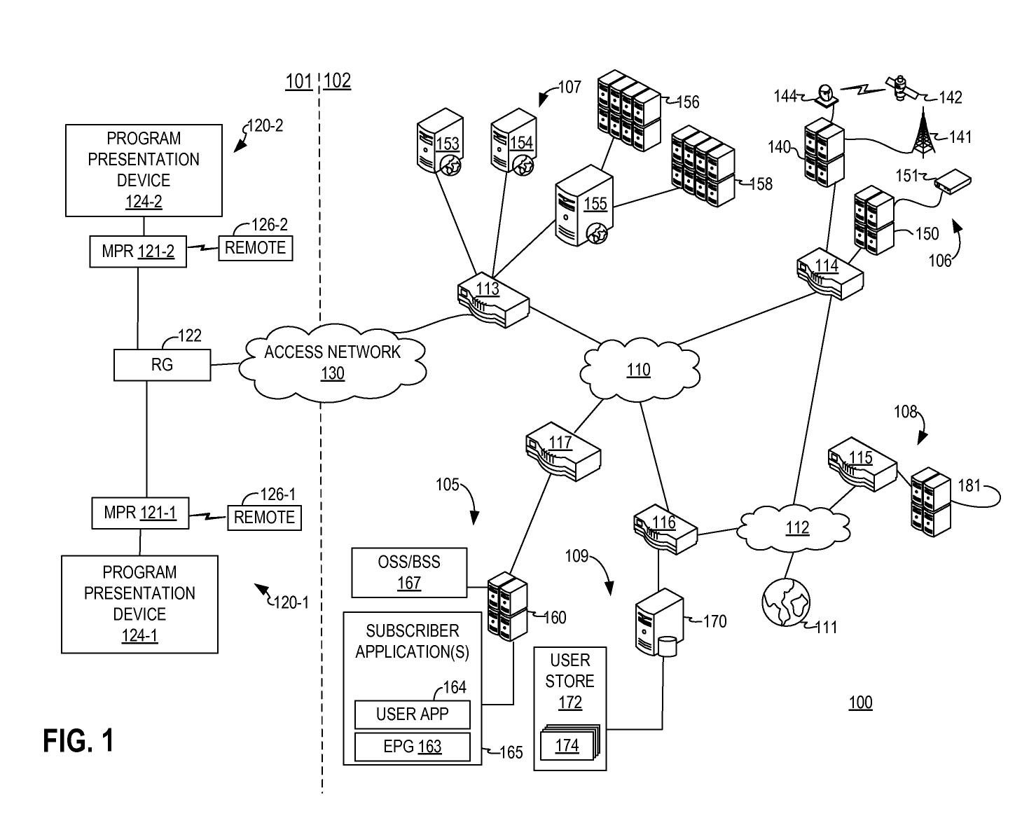

As background for understanding disclosed embodiments, exemplary systems for delivering multimedia content are described below. Disclosed embodiments are described in sufficient detail to enable one of ordinary skill in the art to practice the disclosed subject matter without undue experimentation. It should be apparent to a person of ordinary skill that the disclosed examples are not exhaustive of all possible embodiments. Regarding reference numerals used to describe elements in the figures, a hyphenated form of a reference numeral may refer to a specific instance of an element and an un-hyphenated form of the reference numeral may refer to the element generically or collectively. Thus, for example, in FIG. 1, element 121-1 refers to an instance of an MPR, which may be referred to collectively as MPRs 121 and any one of which may be referred to generically as an MPR 121.

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a large number of multimedia content channels (also referred to herein as “channels”), each occupying a different frequency band or frequency channel, through a coaxial cable, a fiber-optic cable, or a combination of the two. The bandwidth required to transport simultaneously a large number of multimedia channels may challenge the bandwidth capacity of cable-based networks. In these types of networks, a tuner within an STB, television, or other form of receiver may be required to select a channel from the mixed signal for playing or recording. A user wishing to play or record multiple channels typically needs to have distinct tuners for each desired channel. This can be an inherent limitation of cable networks and other mixed signal networks.

In contrast to mixed signal networks, IPTV networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies to distribute multimedia content. Instead of being associated with a particular frequency band, an IPTV television program, movie, or other form of multimedia content is a packet-based stream that corresponds to a particular network endpoint, e.g., an IP address and a transport layer port number. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an indication of a network endpoint that is associated with the desired channel.

IPTV may be implemented, at least in part, over existing infrastructure including, for example, a proprietary network that may include existing telephone lines, possibly in combination with customer premises equipment (CPE) including, for example, a digital subscriber line (DSL) modem in communication with an STB, a display, a program presentation device (e.g., a television), and other appropriate equipment to receive multimedia content and convert it into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as VOD, pay-per-view (PPV), EPGs, and the like. Bidirectional networks may also enable a service provider to collect information related to a user's preferences, whether for purposes of providing preference based features to the user, providing potentially valuable information to service providers, or providing potentially lucrative information to content providers and others.

Referring now to the drawings, FIG. 1 illustrates selected aspects of an MCDN 100 for providing controlled access to multimedia content in accordance with disclosed embodiments. MCDN 100, as shown, is a multimedia content provider network that may be generally divided into a client side 101 and a service provider side 102 (a.k.a., server side 102). Client side 101 includes all or most of the resources depicted to the left of access network 130 while server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical cables that connect a subscriber's home or business to a local exchange. In these embodiments, the physical layer of access network 130 may include both twisted pair copper cables and fiber optics cables. In a fiber to the curb (FTTC) access network, the “last mile” portion that employs copper is generally less than approximately 300 feet in length. In fiber to the home (FTTH) access networks, fiber optic cables extend all the way to the premises of the subscriber.

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

Access network 130 may transmit radio frequency (RF) signals over coaxial cables. In these embodiments, access network 130 may utilize quadrature amplitude modulation (QAM) equipment for downstream traffic. Also in these embodiments, access network 130 may receive upstream traffic from a consumer's location using quadrature phase shift keying (QPSK) modulated RF signals.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements (e.g., emergency alert system messages) from local entities. The regional VHOs may then deliver the local and national content to users served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 may communicate over a public network 112, including, for example, an Internet or other type of Web network which is signified in FIG. 1 by the World Wide Web icon 111.

As shown in FIG. 1, client side 101 of MCDN 100 depicts two of a potentially large number of client side resources referred to herein simply as client(s) 120. Each client 120, as shown, includes an MPR 121, a residential gateway (RG) 122, a program presentation device 124, and a remote control device 126. In the depicted embodiment, MPR 121 communicates with server side devices through access network 130 via RG 122.

As shown in FIG. 1, RG 122 may include elements of a broadband modem (e.g., DSL modem or cable modem) and may communicate over wireless and/or wired interfaces. In addition, RG 122 may have elements of a firewall, router, switch, and access point for local area network (LAN) devices to communicate through wired and wireless (e.g., WiFi) Ethernet or other suitable networking technologies. In some embodiments, MPR 121 is a uniquely addressable Ethernet compliant device. Program presentation device 124 may be, for example, any National Television System Committee (NTSC) and/or Phase Alternating Line (PAL) compliant program presentation device. Both MPR 121 and program presentation device 124 may include any form of conventional frequency tuner. As shown, remote control device 126 communicates wirelessly with MPR 121 using infrared (IR) or RF signaling.

In IPTV compliant implementations of MCDN 100, clients 120 are configured to receive packet-based multimedia streams from access network 130 and process the streams for presentation on program presentation devices 124. In addition, clients 120 are network-aware resources that may facilitate bidirectional-networked communications with server side 102 resources to support network hosted services and features. Because clients 120 are configured to process multimedia content streams while simultaneously supporting more traditional Web like communications, clients 120 may support or comply with a variety of different types of network protocols including streaming protocols such as real-time transport protocol (RTP) over user datagram protocol/Internet protocol (UDP/IP), as well as web protocols such as hypertext transport protocol (HTTP) over transport control protocol (TCP/IP).

The server side 102 of MCDN 100, as depicted in FIG. 1, emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down-linked signals transmitted by a satellite 142 and received by a parabolic dish 144. In addition, live acquisition server 140 may acquire programming feeds transmitted via high-speed fiber feed or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. Live acquisition server 140 is communicatively coupled to an encoder which, prior to transmission, encodes acquired content using for example, Motion Picture Expert Group (MPEG) standards such as MPEG-2, MPEG-4, a Windows Media Video (WMV) family codec, or another suitable video codec.

Content delivery resources 107, as shown in FIG. 1, are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content according to the network communication protocol stack in use. These data packets are then transmitted across a network to a receiver (e.g., MPR 121 of client 120), where the content is parsed from individual packets and re-assembled into multimedia content suitable for processing by a decoder.

User requests received by content delivery server 155 may include an indication of the content that is being requested. In some embodiments, this indication includes a network endpoint associated with the desired content. The network endpoint may include an IP address and a transport layer port number. For example, a particular local broadcast television station may be associated with a particular channel and the feed for that channel may be associated with a particular IP address and transport layer port number. When a user wishes to view the station, the user may interact with remote control device 126 to send a signal to MPR 121 indicating a request for the particular channel. When MPR 121 responds to the remote control signal, the MPR 121 changes to the requested channel by transmitting a request that includes an indication of the network endpoint associated with the desired channel to content delivery server 155.

Content delivery server 155 may respond to such requests by making a streaming video or audio signal accessible to the user. Content delivery server 155 may employ a multicast protocol to deliver a single originating stream to multiple clients. When a new user requests the content associated with a multicast stream, there may be latency associated with updating the multicast information to reflect the new user as a part of the multicast group. To avoid exposing this undesirable latency to a user, content delivery server 155 may temporarily unicast a stream to the requesting user. When the user is ultimately enrolled in the multicast group, the unicast stream is terminated and the user receives the multicast stream. Multicasting desirably reduces bandwidth presentation by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations. To deliver multimedia content, client-facing switch 113 may employ any of various existing or future Internet protocols for providing reliable real-time streaming of multimedia content. In addition to the TCP, UDP, and HTTP protocols referenced above, such protocols may use, in various combinations, other protocols including RTP, real-time control protocol (RTCP), file transfer protocol (FTP), and real-time streaming protocol (RTSP).

In some embodiments, client-facing switch 113 routes multimedia content encapsulated into IP packets over access network 130. For example, an MPEG-2 transport stream may be sent in which the transport stream consists of a series of 188-byte transport packets. Client-facing switch 113, as shown, is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, MPR 121 may access MCDN 100 using information received from client gateway 153. Subscriber devices may access client gateway 153, and client gateway 153 may then allow such devices to access private network 110 once the devices are authenticated or verified. Similarly, client gateway 153 may prevent unauthorized devices, such as hacker computers or stolen STBs, from accessing the private network 110. Accordingly, in some embodiments, when an MPR 121 accesses MCDN 100, client gateway 153 verifies subscriber information by communicating with user store 172 via the private network 110. Client gateway 153 may verify billing information and subscriber status by communicating with an OSS/BSS gateway 167, which may translate a query to the OSS/BSS server 181. Upon client gateway 153 confirming subscriber and/or billing information, client gateway 153 may allow MPR 121 access to IPTV content, VOD content, and other services. If client gateway 153 cannot verify subscriber information (i.e., user information) for MPR 121, for example, because it is connected to an unauthorized local loop or RG, client gateway 153 may block transmissions to and from MPR 121 beyond access network 130.

MCDN 100, as depicted, includes application resources 105, which communicate with private network 110 via application switch 117. Application resources 105, as shown, include application server 160 which is operable to host or otherwise facilitate one or more subscriber applications 165 that are made available to system subscribers. For example, subscriber applications 165, as shown, include EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a user, who may be a subscriber to a service provided by MCDN 100. For example, in accordance with disclosed embodiments, user application 164 may be an application that stores data that includes administrator designated user permission settings, that requires users to log in before receiving multimedia content, that monitors user requests (e.g., channel selections or multimedia program selections) for multimedia content, that applies administrator configured rules and parameters in response to receiving the user requests, and that provides access to multimedia content according to the stored permission settings. User application 164, as illustrated in FIG. 1, emphasizes the ability to extend the network's capabilities by implementing a network-hosted application. Because user application 164 may reside on the network, it generally does not impose any significant requirements or imply any substantial modifications to client 120 including MPR 121. In some instances, an MPR 121 may require knowledge of a network address associated with user application 164, but MPR 121 and the other components of client 120 are largely unaffected.

As shown in FIG. 1, a database switch 116, as connected to applications switch 117, provides access to database resources 109. Database resources 109 include database server 170 that manages a system storage resource 172, also referred to herein as user store 172. User store 172, as shown, includes one or more user profiles 174 where each user profile includes account information and may include preferences information (e.g., permission settings) that may be retrieved by applications, including subscriber applications 165, executing on application server 160.

As shown in FIG. 1, MPR 121 may implement a service for providing limited access to multimedia content received from MCDN 100. Some disclosed embodiments of the service include associating an access level with a user. For example, a user (e.g., a child) may be associated with a “restricted” access level by an unrestricted administrator (e.g., a parent). For users assigned to the restricted access level, the service may include tracking, during a tracking period, an accumulated time that a multimedia program is provided to the user. The service limits access to further multimedia content by the user if the accumulated time exceeds an allotted time during a tracking period. If available, the allotted time includes any rollover time from a previous tracking period, up to a maximum amount.

In an exemplary scenario, a parent acting as an administrator specifies that a child has restricted access to multimedia content through MPR 121 and is allotted two hours of viewing time per day (i.e., per tracking period). Further, the parent specifies that a maximum of thirty minutes may be rolled over each day. Therefore, while the child accesses multimedia content through MPR 121, a timer tracks the viewing time and counts it against the allotted time of two hours per day. If the child is credited any rollover time, it is added to the two hours per day up to an administrator defined maximum amount. The child may be required to log in before access to the multimedia content is provided. The child may be associated with a user account stored on an STB. The user account may be associated with permission settings configured and managed by the parent.

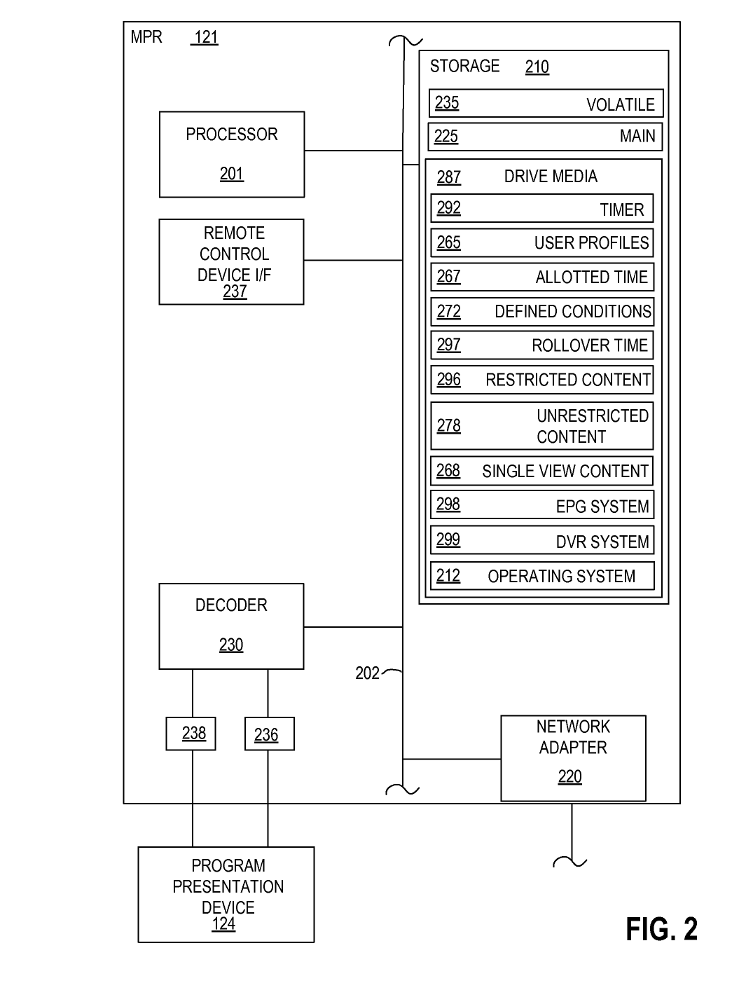

Disclosed systems and methods may be performed local to a viewing location by CPE such as MPR 121. Referring to FIG. 2, a block diagram illustrating selected elements of MPR 121 is presented. In the depicted embodiment, MPR 121 includes a processor 201 communicatively coupled to storage 210 via a shared bus 202. Storage 210 may include main media 225 and volatile media 235. Storage 210 and its components are operable to store instructions, data, or both.

MPR 121 as depicted in FIG. 2 further includes a network adapter 220 that interfaces MPR 121 to access network 130 (FIG. 1), possibly through a residential gateway (e.g., RG 122 in FIG. 1). MPR 121 may be similar to or identical to MPR 121 in FIG. 1 and receive multimedia content such as television content from access network 130 (FIG. 1). In embodiments suitable for use in IP based content delivery networks, MPR 121, as depicted in FIG. 2, may include an audio/video (A/V) decoder 230 that assembles payloads from a sequence or set of network packets into one or more streams of multimedia content. The streams of multimedia content may include audio information and video information and A/V decoder 230 may parse or segregate the two to generate a video stream 238 and an audio stream 236 as shown.

Video and audio streams 238 and 236, as output from A/V decoder 230, may include audio or video information with components that have been compressed, encrypted, or both. A/V decoder 230 may employ any of various widely distributed video decoding algorithms including for example without limitation any of the MPEG standards or WMV standards. Similarly, decoder 230 may employ any of various audio decoding algorithms including for example without limitation: Dolby® Digital, Digital Theatre System (DTS) Coherent Acoustics, and Windows Media Audio (WMA). The video and audio streams 238 and 236, as shown in FIG. 2, are provided by A/V decoder 230 in a format compliant with program presentation device 124, which itself may not be a part of MPR 121. Program presentation device 124 may comply with NTSC, PAL or any other suitable television standard.

MPR 121 may contain computer executable instructions that provide administrators ways to provide users with controlled access to multimedia content. The administrator may configure for each user a profile stored in user profiles module 265. A user may be assigned to an unrestricted access level or a restricted access level. In some embodiments, when a viewing session is started, a user may be asked for log in credentials. If administrator log in credentials are provided, multimedia content may be provided without restriction. If a particular child's log in credentials are provided, disclosed services provide the child access to multimedia content as allowed by the permission settings for that child. For example, for each child or for each member of a restricted class of user, an administrator (e.g., parent) may define within a user profile permission settings that designate an allotted time for viewing multimedia content during a tracking period, the duration of a tracking period, the times during which multimedia content may be viewed, the maximum amount of time that may be rolled over from one tracking period to the next, programs that are designated as permitted for a limited number of accesses, the amount of time that is provided for exercising the limited number of accesses, and other such parameters

As shown, storage 210 includes multiple sets or sequences of instructions. Specifically, embedded in or stored upon drive media 287, which is a tangible computer readable media, are multiple sets or sequences of instructions including operating system 212, timer module 292, allotted time module 267, user profiles module 265, defined conditions module 272, rollover time module 297, restricted content module 296, unrestricted content module 278, single view content module 268, EPG system 298, and DVR system 299. Operating system 212 may be a Unix® or Unix-like operating system, a Windows® family operating system, or another suitable operating system.

As shown in FIG. 2, drive media 287 includes instructions for receiving administrator input that defines a tracking period for tracking receipt of multimedia content by a user, an allotment of time for receipt of multimedia content by the user, and a viewing period for allowing receipt of multimedia content by the user. A user profile may be saved in user profiles module 265 and contain information regarding the amount of multimedia content a user is allowed to receive. For example, user profiles module 265 may contain a user profile for John Doe. An administrator may specify that John Doe is allotted two hours of television time each day, and this value for John Doe may be stored in allotted time module 267.

In disclosed embodiments, an administrator may designate permission settings for John Doe that are stored within user profiles module 265. At the beginning of a viewing session, John Doe may be prompted to enter log in credentials. Log in credentials received by John Doe, or by the user purporting to be John Doe, are compared to stored log in credentials. If received log in credentials match stored log in credentials for John Doe, a user profile for John Doe is accessed from user profiles module 265. John Doe and other users may be members of a restricted access level or an unrestricted access level. If John Doe enters administrator log in credentials or credentials of a member of an unrestricted class, content may be provided to John Doe in an unrestricted fashion. In other words, John Doe may receive multimedia content that is not locally limited by administrator settings restricting viewing time and the like.

If a user profile accessed for John Doe indicates that John Doe is a member of a restricted class, John Doe may be limited to accessing an allotted amount of multimedia content for each tracking period during approved viewing times. In addition, some multimedia programs may be restricted in the number of times John Doe may be provided access. For example, an administrator date may designate that a particular multimedia program is only provided to John Doe for a single view.

After a log in by John Doe, a request by John Doe to receive multimedia content may result in user profiles module 265, for example, accessing allotted time module 267 to determine whether John Doe has any remaining time for viewing multimedia content. If so, John Doe may be provided access to requested multimedia content. During John Doe's access of the multimedia content, timer module 292 tracks the duration of a viewing period and compares it to an allotted time. John Doe may receive, through rollover time, credit for unused viewing time from previous tracking periods. Rollover time may be calculated as the difference between an allotted time and the time used for viewing during a tracking period. Rollover time data may be calculated by and stored within rollover time module 297. After the accumulated time exceeds an allotted time, John Doe may be automatically logged out of a viewing session.

User input to select a multimedia program may be provided through remote control interface 237 through, for example, an “up channel” or “down channel” command. Accordingly, remote control interface 237 is enabled to receive IR signals, radio signals, or other communication signals from a remote control device (e.g., remote control device 126 in FIG. 1). Users may also enter log in credentials through a remote control device (e.g., remote control device 126 from FIG. 1) that communicates through remote control device interface 237.

In implementations of MPR 121 that provide controlled access to multimedia content as disclosed herein, administrator input that defines permission settings for users may be provided to remote control device interface 237 or network adapter 220. For example, an administrator may navigate a graphical user interface provided on program presentation device 124 (e.g., a television) using a remote control device and by providing textual and directional input for the graphical user interface. In addition, administrator input defining and managing permission settings for users and the like may be received by MPR 121 over network adapter 220. For example, network adapter 220 may receive and provide to MPR 121 administrator input and user input received from portable telephony devices (e.g., smart phones) and remote data processing systems (e.g., laptop computers). In some embodiments, network adapter 220 may provide administrators the ability to manage remotely content delivered to users.

As described herein, an administrator may set a number of times a user may access a multimedia program, such as by designating a multimedia program as “approved for a single view” by a user. As shown in FIG. 2, such information may be stored within single view content module 268. Further administrator input may define an allotment of time and a viewing period for receipt of the multimedia content by the user. For example, an administrator may designate a multimedia program as approved for a single viewing within the next two days, and may further designate that no more than two hours, including any breaks, may be spent viewing the multimedia program. The administrator input may be stored as part of user profiles module 265 on a per-user basis, with each user potentially being assigned separate viewing permission settings. In some cases, users may be designated as part of a restricted class, wherein each member of the restricted class is assigned the same permission settings.

As shown in FIG. 2, MPR 121 includes EPG system 298, which operates to provide on program presentation device 124 a list of multimedia programs available to users and, in some embodiments, permission settings available to administrators. While viewing a list of multimedia programs presented on program presentation device 124 by EPG system 298, an administrator may designate certain multimedia content as restricted content for users. In this case, data such as a multimedia program identification number, a multimedia program title, or the like may be stored in restricted content module 296. Similarly, an administrator may designate certain multimedia content as unrestricted content, and data identifying the unrestricted content may be stored in unrestricted content module 278. An example of unrestricted content may be educational content. Some disclosed embodiments may allow administrators to control content that is recorded by users, and in such cases, DVR system 299 may be controlled according to administrator settings stored in user profiles module 265 to permit users to record a designated amount of multimedia content during a designated viewing period.

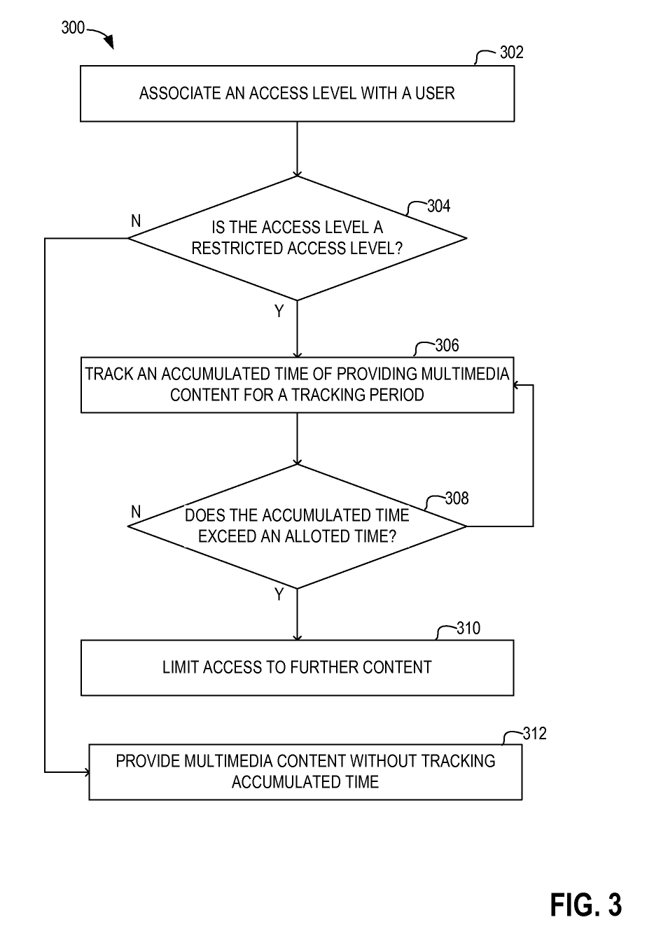

FIG. 3 illustrates selected components of method 300 for providing limited access to multimedia content. As shown, method 300 includes associating (block 302) an access level with a user. Example access levels include without limitation “restricted” and “unrestricted,” “administrator” and “user,” or “parent” and “child.” In an exemplary embodiment, a parent creates separate log in credentials and manages separate permission settings for each child in a family. Upon the beginning of a viewing session, a user may be asked for log in credentials. If the provided log in credentials are (block 304) from a restricted access level associated with children, method 300 includes tracking (block 306) an accumulated time that multimedia content is provided to the user. If the access level associated with the provided log in credentials is an unrestricted access level, method 300 includes providing (block 312) multimedia content without tracking accumulated time. Accumulated time is tracked for a tracking period and then accumulated time is reset with each new tracking period. An example tracking period is one day. In operation of method 300 an accumulated time is compared (block 308) to an allotted time. If the accumulated time exceeds the allotted time, access to further multimedia content is prevented (block 310). In accordance with disclosed embodiments, unused time from the allotted time for a tracking period is rolled over to the next tracking period.

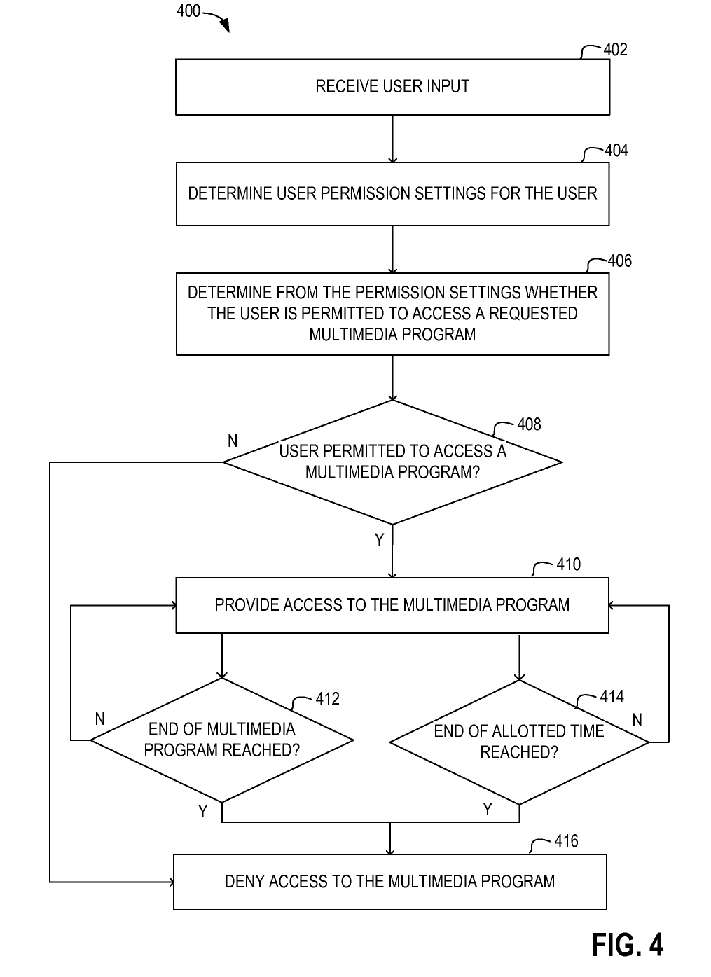

FIG. 4 illustrates selected components of method 400 for providing limited access to a multimedia program. User input is received (block 402) and includes a user access code (e.g., password). In some embodiments, a user access code may include biometric data (e.g., fingerprint data). A determination is made (block 404) whether the user is permitted to receive multimedia content. The determination may be based on any combination of billing data, blackout data, administrator input, permission settings, or the like. For example, an administrator may provide input that limits the amount of time during which a user may receive multimedia content. Accordingly, an administrator (e.g., a parent) may set permission settings for a user (e.g., a child) that limits the user's viewing time to three hours per week. Alternatively, an administrator may set permission settings that limit the user to viewing a particular number (e.g., three) of multimedia programs, regardless of the duration of the multimedia programs.

After a user provides log in credentials to receive multimedia content (e.g., television content), a user may select a multimedia program for viewing. The user may select the multimedia program from a graphical user interface that presents indications (e.g., icons) representing available multimedia programs. After a user selects a multimedia program, a determination is made (block 406) whether the user's permission settings permit access to the requested multimedia program. In some embodiments, a user is allowed to access a multimedia program for a limited number of accesses, such as for a single view. Permission settings related to restricted multimedia programs may be stored in a user profile associated with the user. If the user is permitted (block 408) access to the multimedia program, the multimedia program is provided (block 410) to the user until the end of the multimedia program is reached (block 412) or until the end of the allotted time is reached (block 414). The user is permitted access to a multimedia program, for example, if a designated number of accesses has not been exceeded. For example, if a user is allocated with two views of a multimedia program, and the user has only viewed the multimedia program once, the user would be permitted (block 408) to access the multimedia program. In some embodiments, an administrator may restrict the amount of time that a user has to access the multimedia program. For example, a user may be restricted to accessing a multimedia program for three hours after an initial access to the multimedia program. If the restricted multimedia program is two hours long, this would provide the user with approximately one hour of breaks that may be taken while accessing the multimedia program. In this scenario, if the user is allocated three hours to access the multimedia program and the multimedia program has only been accessed for one hour, the user would be permitted (block 408) further access to the multimedia program. If either the end of the multimedia program is reached (block 412) or the end of the allotted time is reached (block 414), further access to the multimedia program is denied (block 416).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A service for providing limited access to multimedia content received from a multimedia content distribution network, the service comprising:
associating an access level with a user and, if the access level is a restricted access level:
tracking an accumulated time of said providing for a tracking period;
limiting access to further multimedia content by the user if the accumulated time exceeds an allotted time, wherein the allotted time includes rollover time.

2. The service of claim 1, further comprising:
limiting the included rollover time to a maximum amount.

3. The service of claim 2, further comprising:
receiving administrator input defining the maximum amount.

4. The service of claim 1, further comprising:
receiving administrator input defining the allotted time.

5. The service of claim 4, further comprising:
receiving administrator input defining the tracking period.

6. The service of claim 1, further comprising:
receiving administrator input defining the access level for the user; and
receiving administrator input defining a period during which receiving multimedia content is available for the access level.

7. The service of claim 1, further comprising:
if the accumulated time does not exceed the allotted time,
determining a difference in the allotted time and the accumulated time; and
crediting the difference to a future allotted time at a conclusion of said providing.

8. A process for controlling access to a multimedia program, the process comprising:
receiving input from a user;
determining user permission settings associated with the user;
determining from the user permission settings whether the user is permitted access to the multimedia program, wherein the user permission settings define:
a presentation period; and
a time remaining from an allotted time for the presentation period; and
providing access to the multimedia program, if said user is permitted access.

9. The process of claim 8, further comprising:
notifying the user of a denial of access if the user is not permitted access.

10. The process of claim 8, further comprising:
receiving administrator input defining user permission settings;
storing the user permissions settings.

11. The process of claim 8, further comprising:
timing access to restricted content and counting said access against the allotted time; and
timing access to unrestricted content and not counting said access against the allotted time.

12. The process of claim 11, further comprising:
receiving administrator input classifying a portion of multimedia content as restricted content.

13. The process of claim 12, further comprising:
receiving administrator input classifying a portion of multimedia content as unrestricted content.

14. The process of claim 13, further comprising:
permitting unlimited access to unrestricted content.

15. A computer program product stored on at least one tangible computer readable medium, the computer program product including instructions for:
receiving administrator input defining:
a tracking period for tracking receipt of multimedia content by a user;
an allotment of time for receipt of multimedia content by the user; and
a viewing period for allowing receipt of multimedia content by the user;
saving user profile data based on the administrator input;
receiving a log in credential from the user;
comparing the received log in credential to a stored log in credential for the user;
accessing the user profile data responsive to the stored log in credential corresponding to the received log in credential;
receiving a request from the user to access a multimedia program;
comparing an accumulated time associated with the user to the allotment of time;
providing the multimedia program for access if the accumulated time is less than the allotted time and if the request is received during the viewing period;
updating the accumulated time and repeating said comparing during said providing; and
preventing access to the multimedia program responsive to the accumulated time exceeding the allotment of time or expiration of the viewing period.

16. The computer program product of claim 15, wherein said preventing includes logging out the user.

17. The computer program product of claim 15, wherein said preventing includes notifying the user regarding the accumulated time meeting or exceeding the allotment of time.

18. The computer program product of claim 15, further comprising instructions for:
preventing the user from logging in until expiration of the period.

19. The computer program product of claim 15, further comprising instructions for:
adding to an allotted time for a future period if the accumulated time associated with the user is less than the allotment of time upon an end of the period for tracking receipt of multimedia content.
